(19) United States
(12) Patent Application Publication
(10) Pub. No.: US 2008/0173253 A1
(43) Pub. Date: Jul. 24, 2008

(54) PET ENCLOSURE

(75) Inventor: Chuan-Ming YEH, Chuayi City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LINK TREASURE LIMITED, Tortola (VG)

(21) Appl. No.: 12/018,577

(22) Filed: Jan. 23, 2008

(30) Foreign Application Priority Data
Jan. 24, 2007 (TW) 096201372

(51) Int. Cl. A01K 1/03

(52) U.S. Cl. 119/497

(57) ABSTRACT

A pet enclosure includes a pet carrier and a base securable to a car seat. The pet carrier includes a housing, a handle, a door plate and a plurality of ventilating windows distributed on the top of the housing and the door plate, and provides an interior space for accommodating a pet therein. The base is formed with a receiving space for accommodating the housing and a securing slot for securing by a safety seat belt. The latch mechanism has an actuator, a first hooker, an associating member and a second hooker, wherein the actuator is used to drive the first and second hooker through the associating member for either locking the housing on the base or releasing the housing from the base.

### BACKGROUND OF THE INVENTION

1. Field of the Invention

This invention relates to a pet enclosure. More specifically, this invention relates to a pet enclosure that has a base adapted for either fast connecting or releasing from a car seat.

2. Description of the Related Art

Many pet owners enjoy taking their pet along with them when they travel. For example, when taking an extended road trip, many pet owners like to have their pet's companionship for the trip. A number of portable pet enclosures are available to pet owners. Pet owners can thus bring their pets along with them almost anywhere they go.

Traditional pet enclosures lack of securing a device for fast connecting in cars. When put the pet enclosure in car, the bumpy road, braking and acceleration always cause the pet enclosure suffered a non-stopped wobbling, this may cause anxiety and may hurt the pet.

### SUMMARY OF THE INVENTION

The present invention intends to provide an improved pet enclosure to mitigate or obviate the aforementioned problems.

The present invention achieves its intended purposes, objects and advantages over the prior art through a new and useful structure which includes a pet carrier, a base and a latch mechanism. The pet carrier includes a housing, a handle, a door plate and a plurality of ventilating windows distributed on the top of the housing and the door plate, and provides an interior space for accommodating a pet therein.

The base is formed with a receiving space for accommodating the housing and a securing slot for securing by a safety seat belt.

The latch mechanism has an actuator, a first hooker, an associating member and a second hooker. The actuator is used to drive the first and second hooker through the associating member for either locking the housing on the base or releasing the housing from the base.

Additional features and advantages of the invention will be set forth in the description to follow, and in part will be apparent from the description, or may be learned by practice of the invention. The objectives and other advantages of the invention will be realized and attained by the structure particularly pointed out in the written description and claims as well as the appended drawings.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a side view of an embodiment of the pet enclosure according to the present invention;

FIG. 2 is a partial exploded perspective view of the pet enclosure of FIG. 1;

FIG. 3 is a side view of a housing of the pet enclosure of FIG. 1;

FIG. 4 is an end cross-sectional view of the pet enclosure of FIG. 1.

### DETAILED DESCRIPTION OF THE PREFERRED EMBODIMENTS

Reference will now be made in detail to the preferred embodiments of the present invention, examples of which are illustrated in the accompanying drawings.

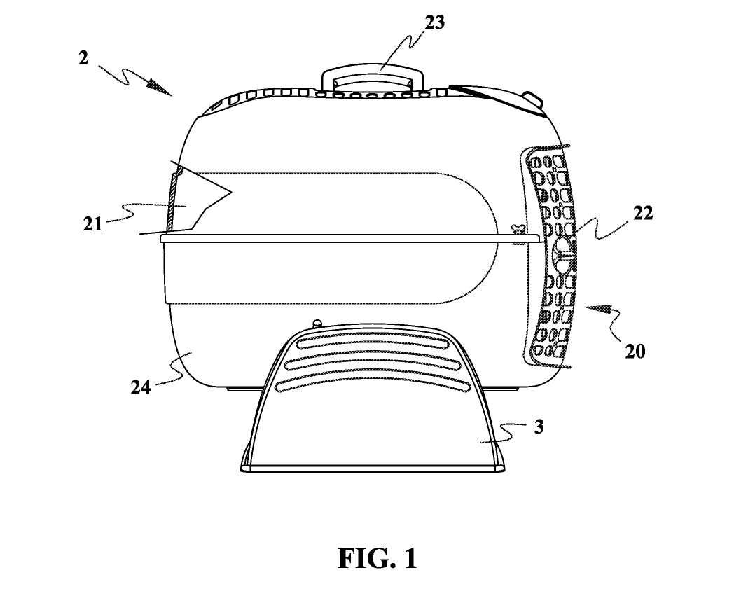

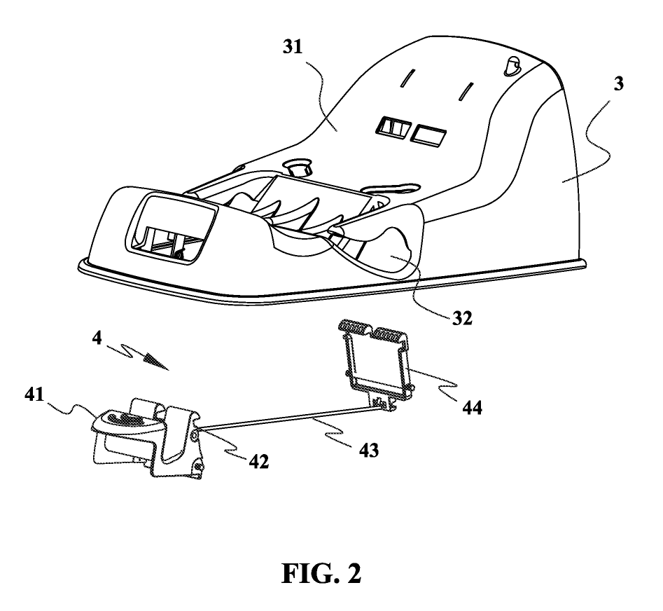

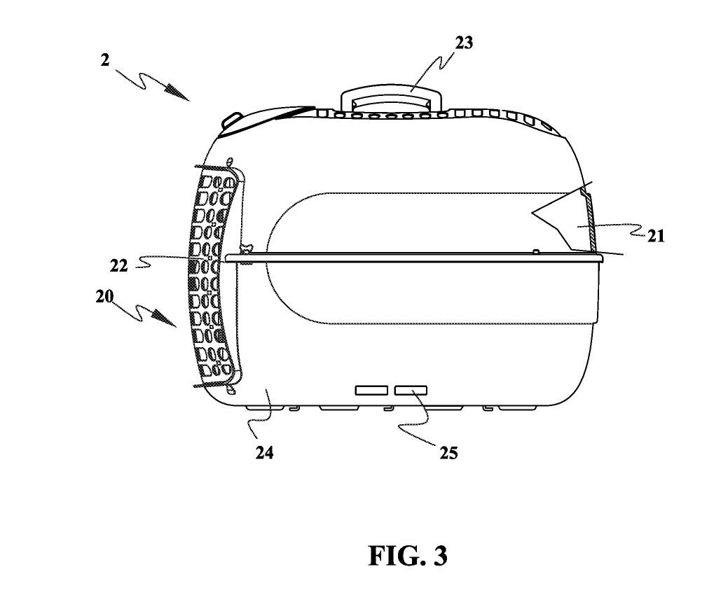

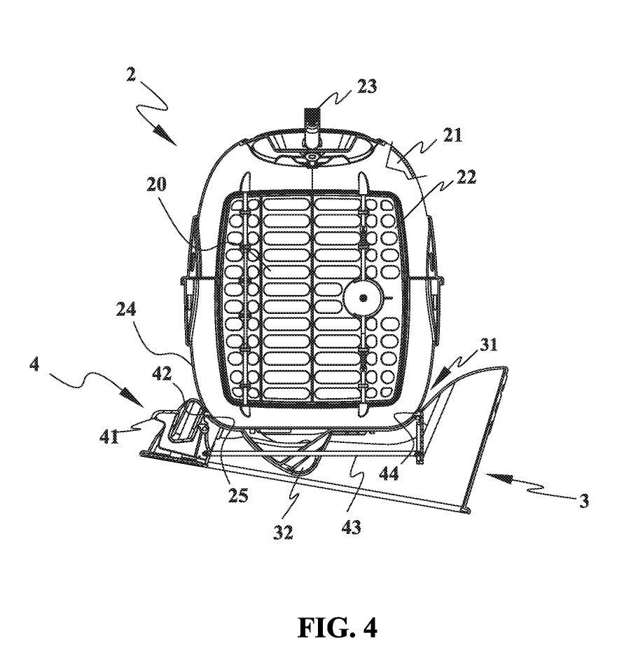

Referring to FIGS. 1 to 4, an embodiment of pet enclosure according to the invention includes a pet carrier 2, a base 3 and a latch mechanism 4. The pet carrier 2 includes a housing 24, a handle 23, a door plate 22 and a plurality of ventilating windows 20 distributed on the top of the housing and the door plate 22, and provides an interior space 21 for accommodating a pet therein.

The base 3 is formed with a receiving space 31 for accommodating the housing 24 thereon and a securing slot 32 for securing by a safety seat belt (not shown) on a car seat.

The latch mechanism 4 has an actuator 41, a first hooker 42, an associating member 43 and a second hooker 44. The actuator 41 may be pivoted on one end of the base 3 for driving the first and second hooker 42 and 44 through the associating member 43 for either locking the housing 24 on the base 4 or releasing the housing 24 from the base 4.

Preferably, the actuator 41 and the first hooker 42 may be made of metal or plastic and formed integrally.

The housing 24 may be formed with an engagable portion 25 for engaging with the first and second hooker 42 and 44. The engagable portion 25 may be an indent, a slot or a protruded rib formed relative to the first and second hooker 42 and 44.

It will be apparent to those skilled in the art that various modifications and variations can be made in the infant carrier, stroller, and base system of the present invention without departing from the spirit or scope of the invention. Thus, it is intended that the present invention cover the modifications and variations of this invention provided they come within the scope of the appended claims and their equivalents.

What is claimed is:

1. A pet enclosure, comprising:
a pet carrier having a housing provided a interior space for accommodating a pet;
a base connectable to a car seat; and
a latch mechanism for securing the pet carrier on the base.

2. The pet enclosure of claim 1, wherein the pet carrier has a handle.

3. The pet enclosure of claim 1, wherein the pet carrier has a door plate.

4. The pet enclosure of claim 3, wherein the door plate has a plurality of ventilating windows.

5. The pet enclosure of claim 1, wherein the housing has an engagable portion for engaging with the latch mechanism.

6. The pet enclosure of claim 1, wherein the base is formed with a securing slot for securing to a car seat by a safety seat belt.

7. The pet enclosure of claim 1, wherein the base is formed with a receiving space for accommodating the housing thereon.

8. The pet enclosure of claim 4, wherein the pet carrier is connectable to the base in either end direction, so as allowing an owner of the pet watching the pet through the ventilating windows on the door plate.

9. The pet enclosure of claim 4, wherein the latch mechanism includes
a first hooker for securing the house on the base;
a second hooker for securing the house on the base;
an associating member for associating the first hooker and second hooker; and
an actuator for driving the first hooker and second hooker.

10. The pet enclosure of claim 9, wherein the actuator and the associating member are formed integrally.

11. The pet enclosure of claim 9, wherein the actuator is pivoted on the base.

12. The pet enclosure of claim 9, wherein the actuator is a handle pivoted on the base.
